(19) United States
(12) Patent Application Publication
(10) Pub. No.: US 2013/0101366 A1
(43) Pub. Date: Apr. 25, 2013

(54) DRILL BIT FOR REMOVING BOLTS AND OTHER FASTENERS

(71) Applicant: Mark Sanders, Prestonburg, KY (US)

(72) Inventor: Mark Sanders, Prestonburg, KY (US)

(21) Appl. No.: 13/278,308

(22) Filed: Oct. 21, 2011

(51) Int. Cl. B23B 51/04; B23P 17/00

(52) U.S. Cl. 408/1 BD; 408/204

(57) ABSTRACT

The present invention relates to an article device and method for removing a broken or bound fastener from an opposing hole in an object such as a piece of machinery or an automotive or mechanical piece of equipment. The present invention provides an elongated and hollow bit having an inner diameter to match and closely straddle the diameter of the elongated portion (e.g., threaded portion) of the fastener. The article of the present invention may be coupled to a drill via an optional adaptor and/or shank. The method of the present invention may further include predrilling the hole removing the head of the fastener and/or rethreading the hole once the fastener is removed.

### BACKGROUND

1. Field of the Invention

The present invention relates to an article and method for extracting bolts or fasteners that have become broken or bound and difficult to remove.

2. Related Art

Individual metal parts, pieces and components of machinery are generally held together with various bolts. screws or other fasteners. Bolts or screws may be inserted in opposing holes in two pieces of a machine and held together by use of a nut. Alternatively, bolts and screws may be fastened into an opposing hole that has matching threads. Many types of machines are exposed to the external environment and/or intense heating or combustion processes. Thus, fasteners used to assemble parts of these machines may be prone to corrosion and rust as well as expansion and contraction caused by temperature variations. Corrosion and rust can cause the fastener to become bound to the opposing hole and/or weak and susceptible to breakage under pressure. Similarly, heating and cooling caused by changing environments and/or proximity to combustion or high temperature processes may also cause increased weakness and breakage over time.

For example. automobile parts and components, such as a transmission, manifold, engine. etc., may be subjected to intense heating and cooling caused by its proximity to the catalytic converter and/or engine. Such rapid and repeated rounds of heating (and then cooling when the automobile is turned off or idle) may produce a lot of strain and wear-and-tear on fasteners used to assemble and hold these parts together. Automobile parts and components may also be subjected to corrosion caused by exposure to the external air, water and salt on the road. Thus, it is common for bolts in the transmission, manifold or head of the engine to become broken or bound, which may lead to leaks of fluid and improper performance and operation of the automobile component.

When a fastener becomes broken or bound (e.g., corroded) inside an opposing hole of a piece of a machine, it can be difficult to remove or extract the broken or bound fastener (especially with smaller screws or bolts) so that the fastener can be replaced. In the case of fasteners secured to an opposing threaded hole, devices having a left-handed screw thread, such as an Easy Out tool, may be used to dig into the bound or broken fastener and provide enough torque to unscrew it out of the hole. However, these left-handed extractors do not always work. An uneven broken surface on the fastener, too much corrosion or bonding of the fastener to the hole, or the inability to generate enough torque may each make extraction with left-handed extractors difficult.

Thus, there is a need for a new article and method for the removal of broken or bound fasteners when the fastener cannot be removed by forcibly unscrewing or pulling it from the hole for replacement.

### SUMMARY

According to a first broad aspect, an article is provided for removing a fastener comprising: a hollow and elongated bit made of metal having a coupling portion at a proximal end of the bit and a circular cutting surface at a distal end of the bit, wherein the bit has a circular cross-sectional shape within a cutting portion near the distal end of the bit in a plane perpendicular to the longitudinal axis of the bit, the circular cross sectional shape of the bit defining an interior space within the cutting portion of the bit configured to receive a cutout containing the fastener during use in cutting.

According to a second broad aspect of the present invention, an article is provided for removing a fastener comprising: a bit portion; a shank portion; and a bridge portion, wherein the article is elongated and has a proximal end and a distal end, wherein the bit portion is disposed at the distal end and the shank portion is disposed at the proximal end, wherein the bit portion is integrally connected to the shank portion by the bridge portion, wherein the bit portion has a circular cutting surface at the distal end, and wherein the bit portion is hollow and has a circular cross-sectional shape within a cutting portion near the distal end of the bit portion in a plane perpendicular to the longitudinal axis of the article, the circular cross sectional shape of the bit portion defining an interior space within the cutting portion configured to receive a cutout containing the fastener during use in cutting.

According to a third broad aspect of the present invention, a method for removing a fastener from a hole of an object comprising: drilling out the fastener using a hollow and elongated bit made of metal having a circular cutting surface at a distal end of the bit, wherein the bit has a circular cross-sectional shape within a cutting portion near the distal end of the bit in a plane perpendicular to the longitudinal axis of the bit, wherein the inner circular cross-sectional diameter at the distal end of the bit is slightly greater than the diameter of an elongated portion of the fastener to be removed such that the hollow and elongated bit closely straddles the fastener during cutting.

### BRIEF DESCRIPTION OF THE DRAWINGS

The accompanying drawings. which are incorporated herein and constitute part of this specification, illustrate exemplary embodiments of the invention, and, together with the general description given above and the detailed description given below, serve to explain the features of the invention.

FIG. 1A is a perspective view of a bit according to an embodiment of the present invention:

FIG. 1B is a side view of the bit in FIG. 1A;

FIG. 1C is a cross-sectional view of the bit in FIGS. 1A and 1B through plane defined by dotted line and arrows labeled A in FIG. 1B;

FIG. 2A is a perspective view of an adaptor according to an embodiment of the present invention;

FIG. 2B is a side view of the adaptor in FIG. 2A;

FIG. 2C is a cross-sectional view of the adaptor in FIGS. 2A and 2B through plane defined by dotted line and arrows labeled B in FIG. 2B;

FIG. 3 is an article according to an embodiment of the present invention with a bit.

adaptor and shank assembled together:

FIG. 4A is a perspective view of a bit according to an embodiment of the present invention;

FIG. 4B is a cross-sectional view of the bit in FIG. 4A through a plane defined by dotted line and arrows labeled C;

FIG. 4C is a perspective view of a bit according to an embodiment of the present invention;

FIG. 4D is a cross-sectional view of the bit in FIG. 4C through a plane defined by dotted line and arrows labeled D;

FIG. 4E is a perspective view of a bit according to an embodiment of the present invention;

FIG. 4F is a cross-sectional view of the bit in FIG. 4E through a plane defined by dotted line and arrows labeled E;

FIG. 5 is a perspective view of an article according to an embodiment of the present invention having a bit and shank for directly coupling together; and

FIG. 6 is a perspective view of an integrated article according to an embodiment of the present invention having a bit portion and a shank portion.

### DETAILED DESCRIPTION OF THE INVENTION

### Definitions

For purposes of the present invention. “bound” refers to a state or condition of a fastener being stuck or otherwise unable to be removed or unscrewed from a corresponding or opposing hole of a metal object for receiving the fastener using normal methods and/or a normal amount of force. A fastener may be “bound” in addition to being broken.

For purposes of the present invention, the term “elongated” refers to a bit having a length along its longitudinal axis that is greater than its diameter in a cross-sectional plane perpendicular to the longitudinal axis.

For purposes of the present invention, the term “longitudinal axis” refers to the axis through the center of the bit in the lengthwise direction of the bit. For example, the “longitudinal axis” may refer to the major or cylindrical axis around which the bit is generally symmetrically arranged.

For purposes of the present invention, the term “substantially cylindrical” refers to a bit of the present invention having parallel opposing sides or nearly parallel opposing sides (with a possible slight angle or taper) along its entire length or at least along its cutting portion. The term “substantially cylindrical” may also refer to a bit having a generally constant or nearly constant inner and/or outer diameter along its entire length or at least along its cutting portion.

For purposes of the present invention. the term “cutting portion” refers to the portion of the bit along its length having an interior space or lumen for receiving the cutout, plug or fastener being removed during cutting. The term “cutting portion” may also refer to the portion of the bit that is capable of becoming submerged or recessed in the surrounding material or hole of a metal object during cutting depending on the depth of the cut. The “cutting portion” is distinguished from a neck portion containing a coupling portion.

For purposes of the present invention. the term “neck portion” refers to the portion of the bit along its length from the proximal side of the cutting portion to the proximal end of the bit that generally corresponds to the portion of the bit having a coupling portion, such as a threaded portion, for releasable and/or reversibly coupling to a separate hub, adaptor, arbor, shank. etc. The term “neck portion” may also refer to the portion of bit lacking an interior space of lumen for receiving the cutout, plug or fastener being removed.

For purposes of the present invention, the term “object” refers to any object made of metal, such as a piece of automotive or mechanical equipment, machinery or any other piece of material made of a metal(s), such as aluminum or cast iron, having an opposing or corresponding hole formed therein for receiving a fastener.

For purposes of the present invention, the term “surrounding material” refers to the material of an object made of metal having an opposing or corresponding hole formed therein for receiving a fastener. Thus, “surrounding material” would include the material of the metal object surrounding the hole for receiving the fastener.

For purposes of the present invention. the term “teeth” refers to a jagged edge formed into the distal edge or rim of a bit or sheet (coupled to the bit) that is used to cut into a material of a metal object by contacting the material of the object and moving of the teeth in relation to such material.

For purposes of the present invention, a “shank” refers to an elongated and solid piece that may have sloped sides for insertion into. and gripping by, a chuck of a drill, whereas an “arbor” may be loosely defined as a shank with an adaptor for exchanging bits.

For purposes of the present invention, the term “one-piece” refers to an article of the present invention made of a continuous material without breaks or junctions.

For purposes of the present invention, a “fastener” refers to any fastener that may be used to hold two or more objects together by inserting the fastener into a corresponding or opposing hole in at least one of the objects. The fastener will generally comprise an elongated portion, such as a threading or threaded portion, for insertion into the hole, and a head portion wider than the hole to stop the advancement of the fastener into the hole beyond a point. For example, the fastener may be a screw. bolt. etc.

For purposes of the present invention, the “periphery” in reference to a fastener refers to the outer circumference or surface on the side of the elongated portion of a fastener.

For purposes of the present invention, the term “straddle” refers to an elongated bit of the present invention having a hollow cutting portion with a circular cross-section diameter that closely surrounds or straddles the periphery of the elongated portion of a fastener to be removed with very little space between them.

### Description

Broad aspects of the present invention provide an article. device and method for removing a broken or bound fastener, such as a bolt, screw. etc., in a corresponding or opposing hole of a metal object. This may be especially useful in situations where a left-handed extractor may be ineffective at removing the fastener from a threaded hole. The present invention generally comprises an elongated and hollow bit having an inner circular cross-sectional diameter corresponding to the diameter of a bolt or fastener to be extracted. For example, the inner diameter of the hollow bit of the present invention may be slightly greater than the diameter of the bolt or fastener to be extracted. Although the hollow bit may be generally or substantially cylindrical in shape, the sides of the bit along its length may not be perfectly parallel. For example, there may be a slight angle or taper along the length or longitudinal axis of the hollow bit such that the cross-sectional diameter at one end of the bit is slightly different than the cross-sectional diameter at the other end.

Unlike a standard solid drill bit, the hollow bit of the present invention allows for cutting of the metal only in a circle around or at an edge, perimeter or circumference of the fastener broken or bound in the hole. This decreases the friction and reduces the amount of material that must be carved or cut away in comparison to a solid bit and/or drilling or cutting through or into the fastener. Instead of boring a hole through or into the broken or bound fastener itself material of an object having a hole formed therein for receiving the fastener may be cut instead, and the cutting surface or area may only be in a circle (matching the cross-section of the hollow bit) around or at an edge, perimeter or circumference of the fastener, such that the interior of the circular cut is left intact during cutting to form a cutout or plug containing the fastener that may then be removed. Once the cutout or plug is removed, the hole may then be re-threaded for receiving a new fastener.

Use of articles and methods of the present invention may be facilitated by the fact that the material surrounding the hole in the object for receiving the fastener may often be made of a softer metal relative to the fastener itself. For example, the material of the object surrounding the hole formed therein for securing or receiving the fastener (e.g., by having a threaded hole former therein for receiving a bolt or screw), may be made of a softer or more easily cut material, such as cast iron or aluminum, whereas the fastener itself may be made of a relatively harder material, such as steel.

One of the key advantages and features of an article. device or method of the present invention is that the interior space (i.e., inner circular cross-sectional diameter) of the bit at and near the distal end of the bit may generally be slightly larger than the diameter of the fastener to be removed such that the bit will closely straddle or surround an elongated portion (e.g., a threaded portion) of the fastener. In those cases where the fastener is made of a harder metal than the surrounding material of the object into which the fastener is secured, the fastener itself will serve as a guide for keeping the bit of the present invention centered around, and aligned with, the fastener because the bit will preferentially cut the softer or more-easy-to-cut material of the object surrounding the fastener. Unlike a hole saw or circle cutter, the elongated hollow bit of the present invention does not include a pilot bit to guide and keep it positioned because the bit of the present invention may be kept in place by closely straddling the harder and more-difficult-to-cut fastener (as well as by the existing hole itself in the surrounding material). Indeed, hole saws have a tendency to “walk” if not used with a pilot bit. However, articles and methods of the present invention may also be used when the fastener and surrounding material of the object are made of the same material or materials having similar properties. In these cases, the positioning of the bit of the present invention may still be guided by the hole itself. In any case, a starter hole slightly wider than the existing hole of the object for receiving the fastener may be predrilled with a standard bit prior to using the elongated hollow bit of the present invention to facilitate its use.

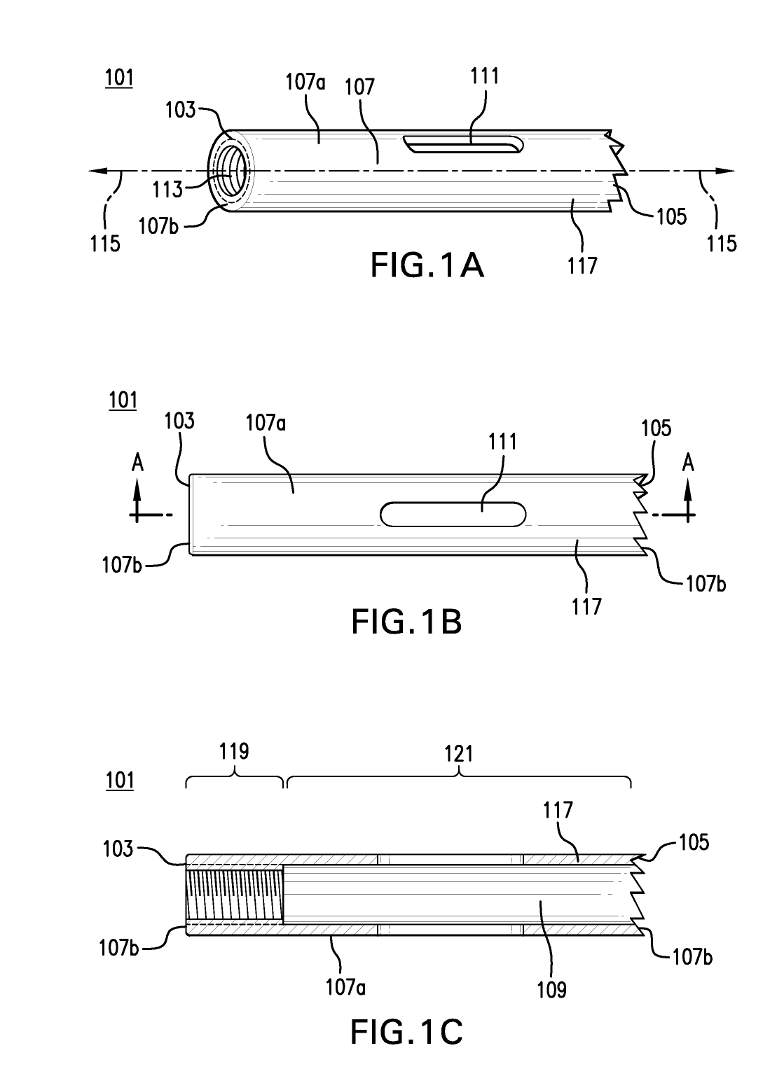

According to an embodiment shown in FIG. 1, the present invention may comprise an elongated and hollow bit 101 with an interior space or lumen inside the bit 101. The hollow bit 101 may be elongated in a direction along its main axis 115. The hollow bit 101 may have a generally or substantially columnar, tube-like or cylindrical shape with a generally circular cross-section in a plane perpendicular to its main or longitudinal axis 115. As shown in the embodiment in FIG. 1A, the bit 101 may have a proximal end 103 and a distal end 105, with one or both of the proximal end 103 and the distal end 105 open to the environment when viewed alone (i.e., not coupled to an adaptor or shank). The bit 101 in FIG. 1A may have a threaded portion, such as an inner threaded portion 113, or other kind of coupling portion (not shown) at or near proximal end 103 in neck portion 119 of bit 101 for releasable and/or reversible attachment or coupling to a hub, adaptor, arbor, shank, etc., which would then close the proximal end 103 of bit 101 when coupled thereto for use with a drill. The exterior surface 107 of bit 101 may include a side surface 107a and an edge or rim 107b present at both the proximal end 103 and the distal end 105. Side(s) 117 consists of the full thickness of bit 101 in a cutting portion 121 including interior surface 109 and exterior surface 107 of bit along the entire length of bit 101. Side(s) 117 is distinguished from the lumen, space or interior of bit 101 in cutting portion 121. A slot 111 may also be optionally provided in side 117 of bit 101 to allow cut material or shavings to flow out of the interior of bit 101 during cutting and/or to facilitate removal of the plug after cutting is complete. Alternatively, it is also envisioned that one or more holes of any shape (e.g., circular) may also be formed in the side of the bit in place of an elongated slot.

Although bit 101 in FIG. 1 is shown with an inner threaded portion 113 in neck portion 119 for receiving a complementary screw-type outer threading of a hub, adaptor, arbor, shank, etc., the bit may also be releasably and/or reversibly attached or coupled to a hub, adaptor, arbor, shank. etc. by any other appropriate coupling or locking tandem or mechanism, such as a snap lock, etc., which may comprise a first coupling portion on bit and a second coupling portion on the hub. adaptor, arbor. shank. etc., as long as the bit is not allowed to freely rotate in relation to the hub, adaptor, arbor, shank, etc., such that the rotational force of the drill is transferred to the cutting surface of the bit. Even with complementary threaded portion and threading, it is further envisioned that bit may conversely have an outer threaded portion, and the hub, adaptor, arbor. shank. etc., may have an inner threading.

Distal end 105 of bit 101 may have a cutting surface. such as teeth or an abrasive or rough surface. at or on the edge or rim 107b at distal end 105 of bit 101 for actually cutting the material of an object by rotation of the bit 101, which may be powered by a drill. In use, the proximal end 103 of bit will be generally oriented toward a drill (not shown), and the distal end 105 will be oriented toward the surface of a material to be cut. For example, teeth may be cut or formed into the edge or rim 107b at distal end 105 of bit 101. Alternatively, an abrasive substance or coating may be applied or adhered to distal end, or a separate bendable or pre-formed round sheet of metal having teeth formed therein may be coupled or attached to distal end 105 of bit 101 to provide the cutting edge or surface.

According to some embodiments. the teeth of the bit may have a slanted or sawtooth profile or any other profile that may be used for cutting metal. The direction or slant of the teeth may be oriented or slanted alternatively clockwise or counter-clockwise depending on whether the bit will be rotated in a right- or left-handed direction by a drill. The depth of the teeth may also vary and may be deeper or coarser for cutting harder or more-difficult-to-cut metals, such as aluminum, and relatively finer or smaller for cutting softer or more brittle metals, such as cast iron. In addition, one or more grooves may be formed in the bit, such as on the outer surface, from one or more of the recessed portions of the teeth, which may spiral upward. Such grooves may further allow the debris to flow out away from the cutting surface. The bit of the present invention may be made of any type of material or metal, or combinations thereof, known or commonly used in making drill bits or forming cutting surfaces, especially those for cutting metal, and may include, for example, hardened steel. Instead of teeth, the cutting surface of the bit may comprise a rough surface. Any materials or metals forming the cutting edge of the bit may further include any known infusions or coatings (e.g., diamond, titanium, etc.) or other treatments (e.g., tempered, etc.).

FIG. 1B shows a side view of the bit 101 shown in FIG. 1A, and FIG. 1C shows a longitudinal cross-sectional view through plane of bit 101 as represented by dotted line and arrow A in FIG. 1B. The edge or rim 107b as part of exterior surface 107 at both the proximal end 103 and the distal end 105 is shown. In addition to exterior surface 107, interior surface 109 facing toward the interior or lumen of bit 101 is also viewable. The bit 101 has a thickness between interior surface 109 and exterior surface of side 107a as indicated by arrows T. The thickness T of bit 101 may be as small as possible while maintaining enough structural integrity and strength needed for cutting. For example, thickness (T) of sides of bit may be in a range from about 30/1000 (or 3/100) to about 60/1000 (or 6/100) of an inch. The thickness Tat distal end 105 of bit 101 will also define the cutting surface and area. The thickness T and circular cross-sectional diameter of bit 101 at distal end 105 will also determine the size of the plug or cutout created by the cutting.

According to some embodiments, the sides 117 of bit 101 may be angled or tapered along its length such that sides 117 and/or interior surface 109 or side exterior surface 107a are not perfectly parallel to each other. Instead, there may optionally be a slight taper or angle such that the circular cross-sectional diameter at the distal end 105 of bit 101 is slightly greater than the circular cross-sectional diameter at the proximal end 103. For example, such tapering may have an angle of roughly about 0.4° relative to parallel. Such a tapering of sides 117 of bit 101 may help avoid the bit 101 becoming bound in the hole when cutting. Furthermore, the teeth at distal end 105 of bit 101 may optionally be turned slightly inward toward the interior of bit 101 to also help keep the bit 101 from becoming bound.

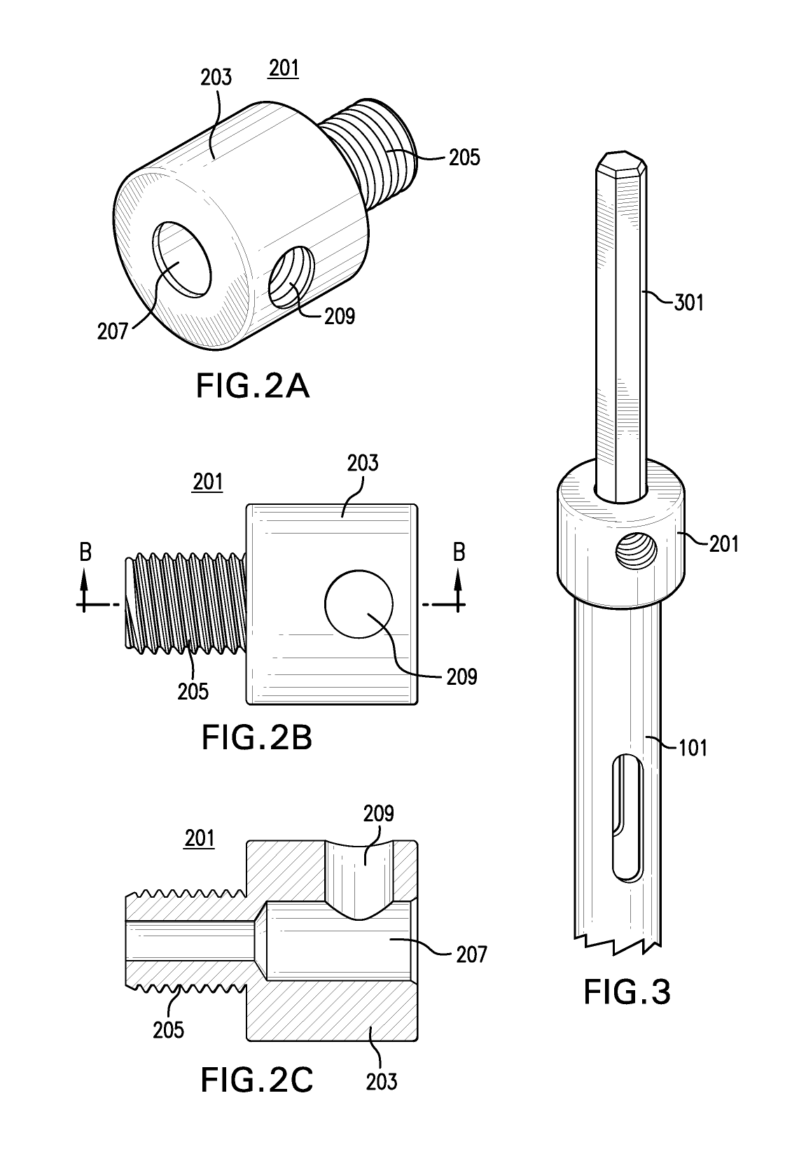

FIG. 2 shows various views of an adaptor 201 that may be used with the bit 101 shown in FIG. 1 for attachment, securement or coupling to the bit 101. The adaptor 201 may also be attached, secured or coupled to a shank at the other end of the adaptor 201, such that the bit 101, adaptor 201 and shank may together form a functional unit for use with a drill (see FIG. 3). As shown in FIG. 2A, adaptor 201 may have a main body portion 203, and an outer coupling portion, such as an outer threaded portion 205. Within main body portion 203 of adaptor 201, there may be an inner threaded portion 209 and a chamber portion 207. The chamber portion 207 is configured to receive one end of a shank or arbor, such that the other end of the shank/arbor may be inserted into a drill (e.g., the chuck of a drill). The shank or arbor may also be secured to the adaptor by a screw (not shown) screwed into inner threaded portion 209 through the side of main body portion 203 of adaptor 201 to tighten down on the side of the shank/arbor. Outer coupling portion, such as outer threaded portion 205, may then couple to the coupling portion of the bit, such as an inner threaded portion 113 in FIG. 1. FIG. 2B shows a side view of the adaptor 201 shown in FIG. 2A, and FIG. 2C shows a cross-sectional view through plane of bit 101 as represented by dotted line and arrow B in FIG. 2B. The cross-sectional view in FIG. 2C shows a clearer view of inside of chamber portion 207 for receiving a shank or arbor.

According to an embodiment of the present invention, FIG. 3 shows a view of an article comprising the bit 101 from FIG. 1, the adaptor 201 from FIG. 2 and a shank 301 assembled together as a functional unit. The shank may be configured for insertion and coupling in the chamber portion of adaptor, and the outer coupling portion of adaptor may be configured for coupling to proximal end of bit. Indeed, an article of the present invention may comprise bit. adaptor and shank coupled together. The shank 301 may be inserted into a drill for cutting at distal end of bit 101. By having the bit 101 connected to the adaptor 201. the bit 101 may be substituted for another bit without having to remove the shank 301 and/or adaptor 201 which may be referred to jointly as an “arbor”) from the chuck of the drill.

According to embodiments of the present invention, the circular cross-sectional diameter of the bit at its distal (cutting) end will generally correspond to the size and diameter of the fastener to be extracted. Fasteners, such as bolts and screws, are generally categorized in terms of size based on the outer diameter of the threads of the fastener. While smaller diameter fasteners are generally more difficult to remove than larger diameter fasteners having a greater surface area, the article and device of the present invention may also be used for removing larger diameter fasteners. The depth of the interior of the bit and/or the overall length of bit will generally be long enough to receive the fastener, plug and/or cutout to be extracted or removed based on the required depth of the cut. For example, the length of the interior of the bit and/or the overall length of the bit may range from about ½ inch to about 2 inches, ad may preferably be about 1¼ of inch long. The length of the arbor or shank portion may be about the standard length.

Thread diameters of fasteners that may be extracted by the article or device of the present invention may range from a ¼ inch to a 1 inch diameter fastener, or more broadly from 1/16 inch to 1 inch, and include, for example, 1/16 inch, ⅛ inch, 3/16 inch, ¼ inch, 5/16 inch, ⅜ inch, 7/16 inch, ½ inch, 5/8 inch, ¾ inch, ⅞ inch, and 1 inch, or any range of diameters bounded by any of these values. On a metric scale, the thread diameters of the fastener to be extracted may range from about 2 mm to 16 mm, such as, for example, 2 mm, 4 mm, 6 mm, 8 mm, 10 mm, 12 mm, 14 mm, and 16 mm, or any range of diameters bounded by any of these values. Fasteners that may be removed by an article or device of the present invention may also include any other size within these ranges. The inner circular cross-sectional diameter of bit at its distal end (measured between two opposing interior surfaces of the bit at the distal end) will generally be about slightly larger than the thread diameter of the fastener to be extracted. For example, the inner circular cross-sectional diameter may be from about 1/1000 to about 10/1000 (or 1/100) of an inch greater than the elongated portion or thread diameter of the fastener, or more preferably from about 2/1000 to about 3/1000 of an inch greater than the elongated portion or thread diameter of the fastener.

Although the bit of the present invention may be used to remove fasteners having a variety of sizes. according to one embodiment, bit 101 in FIG. 1 may be used, for example, to remove an 8 mm broken or bound bolt in an opposing hole of an object, and the diameter of the bit 101 at the distal end 105 might be slightly greater than 8 mm. According to this embodiment, the inner circular cross-section diameter of bit 101 at its distal end 105 may be about 0.315 inches (measured between two opposing interior surfaces 109), and the outer circular cross-section diameter of bit 101 at its distal end 105 may be about 0.425 inches (measured between two opposing exterior surfaces 107). According to such an embodiment, the length of bit 101 may be about 2.3 inches. The optional slot 111 may be positioned such that proximal end of slot 111 may be about 1 inch from the proximal end 103 of bit, and distal end of slot 111 may be about 0.55 inches from distal end 105 of bit 101. Thus, slot may be about 0.75 inches long. Further, according to this embodiment, threaded portion 113 at proximal end 103 for receiving adaptor or shank (see below) may be about 0.5 inches deep from proximal end 103 on interior surface 109 of bit 101. According to this embodiment, adaptor 201 in FIG. 2 may be about 0.91 inches in total length and about 0.63 inches in total width, with main body portion 203 being about 0.53 inches in the length dimension and outer threaded portion 205 being about 0.38 inches, and chamber portion 207 of adaptor 201 may have a diameter of about 0.25 inches.

FIG. 1 presents an example of embodiments where the bit 101 has a roughly constant diameter. It is possible that the shank size and diameter may vary with the size of the bit which may be accommodated by the chuck of the drill being able to clamp down on the However, depending on the size and diameter of the fastener to be removed, the diameter at least at the distal cutting end of the bit may have to be wider or smaller. It would be efficient, convenient and versatile if a single shank or a limited number of shank sizes could be used with a wide range of bit sizes. Accordingly, the inner diameter and/or the outer diameter of the bit may be different between the proximal and distal ends such that the diameter at the distal end is able to vary while the diameter of the inner threaded portion at the proximal end (for coupling to a shank or adaptor) may remain the same. Thus, a single shank or adaptor may be used with bits having different cutting diameters at their distal end.

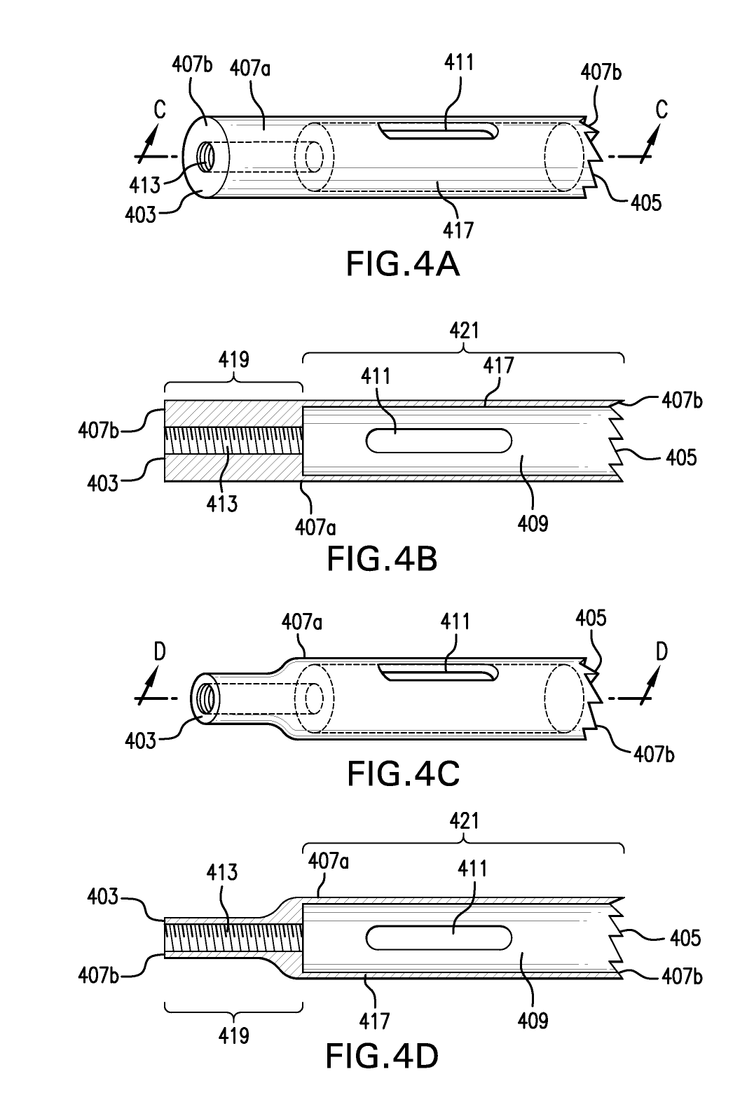

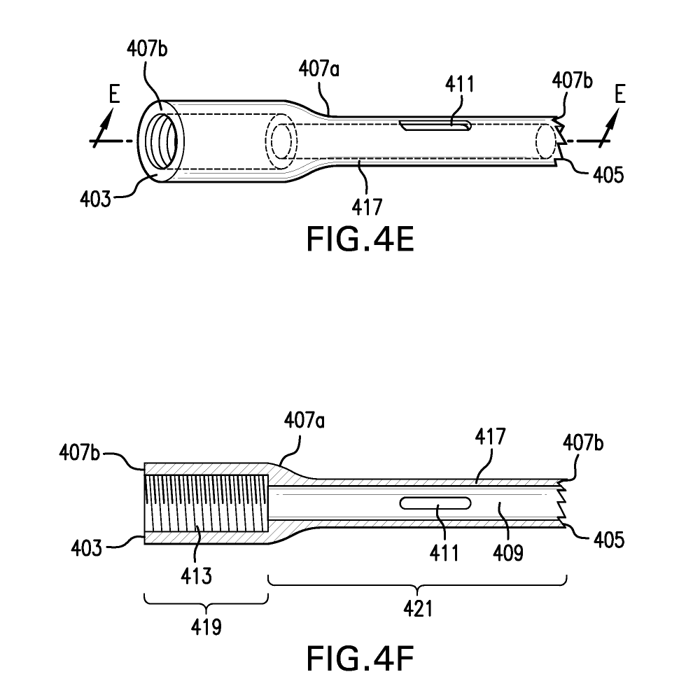

According to some embodiments, the inner diameter of the coupling portion at the proximal end of the bit may be less than the inner diameter of the cutting portion at the distal end of the bit, which may be used to remove a larger fastener. FIGS. 4A and 4B present an embodiment of the present invention of a bit 401 having sides 417 including side surface 407a and a proximal end 403 and a distal end 405. FIG. 4B provides a cross sectional view of the bit in FIG. 4A through plane designated by dotted line and arrows C. As in FIG. 1, a slot 411 may also be provided. To remove a larger fastener, interior space or lumen within cutting portion 421 of bit 401 has a larger diameter than threaded portion 413 in neck portion 419 of bit 401. The larger diameter of the cutting portion 421 and edge 407b at distal end 405 relative to the diameter of the threaded portion 413 within neck portion 419 of bit 401 allows a larger cutting diameter to remove a larger fastener while maintaining the ability to couple to the same shank or adaptor.

According to some embodiments, the outer diameter of the coupling portion at the proximal end of the bit may also be less than the outer diameter of the cutting portion at the distal end of the bit. FIGS. 4C and 4D provide another embodiment of a bit 401 similar to the one in FIGS. 4A and 4B. but without some of the extra thickness in the neck portion 419 such that the outer diameter of the bit 401 in FIGS. 4C and 4D is smaller at the proximal end 403 than at the distal end 405. FIG. 4D provides a cross sectional view of the bit in FIG. 4C through plane designated by dotted line and arrows D. This may allow less material to be used or consumed in making the bit.

According to other embodiments, the inner diameter of the coupling portion at the proximal end of the bit may instead be greater than the inner diameter of the cutting portion at the distal end of the bit. which may be used to remove a smaller fastener. In addition, the outer diameter of the coupling portion at the proximal end of the bit may be greater than the outer diameter of the cutting portion at the distal end of the bit. An embodiment of the present invention is shown in FIGS. 4E and 4F that may be used to remove a smaller fastener. In this embodiment, the outer diameter of bit 401 at the distal end 405 (including the diameter of the cutting surface determined by edge 407b at distal end 405) is smaller than the diameter of the bit 401 at proximal end 403. In other words, the outer diameter of bit 401 in cutting portion 419 is smaller than the diameter of the neck portion 421 of bit 401. This allows for a smaller faster to be removed while being able to couple to a shank or adaptor having a larger diameter. For very small screws, bolts and fasteners, it may not be feasible or practicable to couple to a shank or adaptor having the same small diameter.

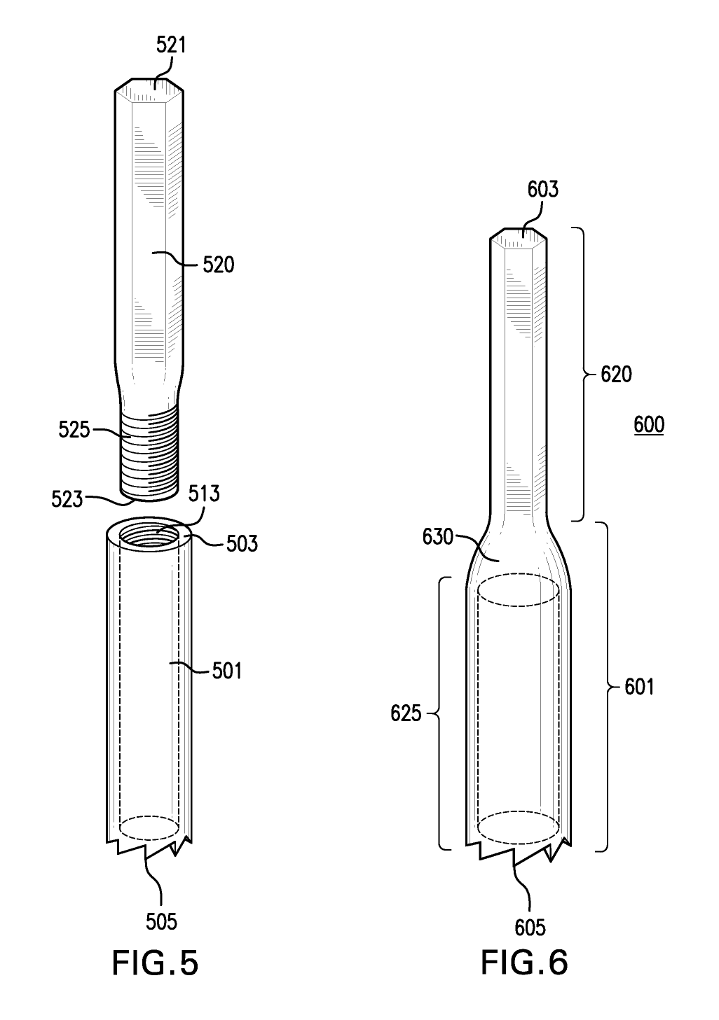

FIGS. 2 and 3 described above provide exemplary embodiments of the present invention for an article or device having three parts to become a functional unit for use with a drill: bit, adaptor and shank. However, it is also envisioned that an article or device of the present invention may instead comprise two pieces or only one piece to form a functional unit that may be used with a drill. As shown in FIG. 5, threaded portion 513 at proximal end 503 of bit 501 may be screwed directly onto outer threading 525 at distal end 523 of shank 520. The article may comprise a coupling portion at proximal end 503 of bit 501 and a second coupling portion at distal end 523 of shank 520, wherein the coupling portion of bit 501, such as a threaded portion, and the corresponding second coupling portion of shank 520, such as a threading, are configured for coupling together. Indeed, the article may comprise bit 501 and shank 520 coupled together. Proximal end 521 of shank 520 (with bit 501 possibly attached or coupled to distal end 523 of shank 520) may then be inserted into the chuck of a drill (not shown) to power drilling at surface or edge at distal end 505 of bit 501. Bit 501 may include any of the bits described above in relation to FIGS. 1 and 4.

FIG. 6 shows another embodiment of the present invention for a one-piece unit or article without breaks or junctions that may be made of a continuous material. The one-piece or integral article or bit 600 in FIG. 6 may comprise an elongated article having a shank portion 620 for coupling to a drill, a bit portion 601 including a cutting portion 625 having an interior space or lumen for receiving a fastener or cutout during cutting, and a bridge portion 630 integrally or continuously connecting the bit portion 625 (disposed at a distal end of the article) and the shank portion 620 (disposed at a proximal end of the article). Proximal end 603 of shank portion 620 may be inserted into a drill to power cutting at edge or cutting surface at distal end 605 of bit portion of one-piece bit 600. Similarly to above, the bit portion may have a circular cutting surface at the distal end, and the bit portion will be hollow and have a circular cross-sectional shape within a cutting portion near the distal end of the bit portion in a plane perpendicular to the longitudinal axis of the article. The circular cross sectional shape of the bit portion will thus define an interior space within the cutting portion for receiving a cutout during use in cutting.

According to another broad aspect of the present invention. a method is provided for removing a fastener broken and/or bound in an opposing or corresponding hole of an object configured to receive the fastener, such as by corresponding threads. For example, the fastener may be broken inside the hole (i.e., with a space from the surface of the object to the broken edge of the fastener). As another example. the fastener may be intact with the head of the fastener above the surface plane of the object but bound or corroded in the hole and unable to be removed by a normal force of rotation.

In those circumstances where a fastener is intact but bound in an opposing or corresponding hole of an object, the portion of the fastener, such as the head of the fastener, above the surface of the object may be cut off or removed in a first step before using the bit of the present invention. By removing the wider portion of the fastener (i.e., the head of the fastener) above the surface of the object, this wider head portion of the fastener, which would otherwise block access to the narrower elongated portion of the fastener in the hole, may be removed such that the bit of the present invention may be used to access and cut around the periphery of the narrower elongated portion of the fastener to ultimately remove the fastener from the hole of the object. This may be done by cutting in a plane at or near the surface of the object such that only the elongated portion of the fastener in the hole is left. A bit of the present invention corresponding to the thread diameter of the fastener may then be used to cut out the remaining portion of the fastener. In those circumstances where a fastener is broken inside an opposing or corresponding hole of an object such that the nearest surface of the fastener is recessed beneath the surface of the object, there will not be a need to remove the head of the fastener because it will already be absent.

In those cases where the opposing or corresponding hole of an object as well as the elongated portion of the fastener is accessible, whether the head portion is already broken off or the head portion was previously removed to expose the elongated portion, methods of the present invention may further include a step of predrilling the existing hole to widen it. This pre-drilling step may be done to facilitate the use of the bit of the present invention by creating a space at least near the entrance of the hole for receiving the bit. By having a wider hole pre-drilled, the outer diameter of the bit of the present invention may be accommodated and set into the hole prior to drilling to help keep the hollow bit from diverging from the position of the hole during drilling. Both the sides of the hole and/or the fastener itself may guide the drilling with the hollow bit of the present invention as described above. Pre-drilling may be performed only to a depth sufficient to receive and guide at least the initial drilling with the bit of the present invention. This pre-drilling step may be performed, for example, with a standard solid drill bit to create the wider starter hole slightly wider than the existing hole to match the outer diameter of the bit.

To remove the fastener, a bit of the present invention as described above having an inner circular cross-sectional diameter at or near its distal (cutting) end corresponding to the diameter of a bolt or fastener to be extracted, such as a bit having an inner circular cross-sectional diameter slightly greater than the diameter of the bolt or fastener to be extracted, may be used. This drilling step may use any of the bits, adaptors, and/or shanks described above. Once drilling is complete or performed to an extent necessary to remove the fastener, the cutout or plug including the fastener is removed. To allow re-use of the drilled on where a threaded fastener is used, any threaded insert known in the art may then be used to replace the threads cut out by the bit of the present invention to receive a replacement fastener. The threaded insert may have threads on the inside and outside with the outer threads used to secure the insert to the hole, and the inner threads used to receive the replacement fastener. Prior to placing the threaded insert in the hole, the hole may be re-threaded to receive the threaded insert (i.e., mate with the outer threads of the insert). Once the threaded insert is appropriately placed in the hole, a new replacement fastener may then be used for the same purpose as the previously broken or bound fastener that was removed by screwing, etc. the replacement fastener into the hole.

While the present invention has been disclosed with reference to certain embodiments. it will be apparent that modifications and variations are possible without departing from the spirit and scope of the invention as defined in the appended claims. Furthermore, it should be appreciated that all examples in the present disclosure, while illustrating embodiments of the invention, are provided as non-limiting examples and are, therefore, not to be taken as limiting the various aspects so illustrated. The present invention is intended to have the full scope defined by the language of the following claims, and equivalents thereof. Accordingly, the drawings and detailed description are to be regarded as illustrative and not as restrictive.

What is claimed is:

1. An article for removing a fastener comprising:
an elongated bit made of metal having a coupling portion at a proximal end of the bit and a circular cutting surface at a distal end of the bit,
wherein the bit is hollow and has a circular cross-sectional shape within a cutting portion near the distal end of the bit in a plane perpendicular to the longitudinal axis of the bit, the circular cross sectional shape of the bit defining an interior space within the cutting portion of the bit configured to receive a cutout containing the fastener during use in cutting.

2. The article of claim 1, wherein the circular cutting surface is on or formed in an edge of the bit at the distal end of the bit.

3. The article of claim 2, wherein the circular cutting surface comprises teeth formed in the edge at the distal end of bit.

4. The article of claim 3, wherein the teeth are angled inward toward the interior space of the cutting portion of the bit.

5. The article of claim 1, wherein at least the cutting portion of the bit is tapered. such that the circular cross-sectional diameter at the distal end of the bit is slightly greater than the circular cross-sectional diameter at the proximal end of the cutting portion.

6. The article of claim 1, wherein a side of the bit defined by the circular cross sectional shape of the bit within the cutting portion surrounds the interior space of the cutting portion and has a thickness corresponding to the circular cutting surface.

7. The article of claim 6, wherein the side of the bit in the cutting portion has a thickness in a range from about 30/1000 to about 60/1000 of an inch.

8. The article of claim 1, wherein the cutting portion has an interior surface facing the interior space and an inner diameter defined as the distance between two opposing interior surfaces in a plane perpendicular to the longitudinal axis, and wherein the inner diameter is substantially consistent along the length of the cutting portion.

9. The article of claim 1, wherein the inner diameter within the cutting portion at the distal end of the bit is slightly greater than a thread diameter of the fastener to be removed.

10. The article of claim 9, wherein the inner diameter within the cutting portion at the distal end of the bit is about 1/1000 to about 10/1000 of an inch greater than the thread diameter of the fastener to be removed.

11. The article of claim 9, wherein the inner diameter within the cutting portion at the distal end of the bit is slightly greater than a fastener having a thread diameter in a range from about 1/16 inch to about ¾ of an inch or in a range from about 2 mm to about 16 mm.

12. The article of claim 1, further comprising a shank having a proximal end and a distal end, wherein the distal end of the shank has a second coupling portion, and wherein the second coupling portion of the shank and the coupling portion of bit are configured for coupling together.

13. The article of claim 1, further comprising an adaptor having a main body portion having a chamber portion and an outer coupling portion, wherein the outer coupling portion is configured to couple with the coupling portion of the bit.

14. The article of claim 13 further comprising a shank having a proximal end and a distal end, wherein the distal end of the shank has a second coupling portion, and wherein the second coupling portion of the shank is configured for coupling to the chamber portion of the adaptor.

15. A one-piece article for removing a fastener comprising:
a bit portion: a shank portion; and a bridge portion,
wherein the article is elongated and has the bit portion disposed at the distal end and the shank portion disposed at the proximal end of the article, wherein the bit portion is integrally connected to the shank portion by the bridge portion,
wherein the bit portion has a circular cutting surface at the distal end, and
wherein the bit portion is hollow and has a circular cross-sectional shape within a cutting portion near the distal end of the bit portion in a plane perpendicular to the longitudinal axis of the article, the circular cross sectional shape of the bit portion defining an interior space within the cutting portion configured to receive a cutout containing the fastener during use in cutting.

16. A method for removing a fastener from a hole o an object comprising:
(a) drilling out the fastener using a hollow and elongated bit made of metal having a circular cutting surface at a distal end of the bit,
wherein the bit has a circular cross-sectional shape within a cutting portion near the distal end of the bit in a plane perpendicular to the longitudinal axis of the bit,
wherein the inner circular cross-sectional diameter at the distal end of the bit is slightly greater than the diameter of an elongated portion of the fastener to be removed such that the hollow and elongated bit closely straddles the fastener during cutting.

17. The method of claim 16, wherein an interior space within the cutting portion defined by the circular cross sectional shape of the bit portion receives a cutout containing the fastener during the cutting step (a).

18. The method of claim 16. wherein the inner circular cross-sectional diameter at the distal end of the bit is slightly greater than the thread diameter of the fastener to be removed during step (a).

19. The method of claim 16, wherein the inner circular cross-sectional diameter at the distal end of the bit is from about 1/1000 to about 10/1000 of an inch greater than the diameter of the elongated portion of the fastener to be removed during step (a).

20. The method of claim 16, wherein the fastener is broken or bound in a corresponding hole in the object.

21. The method of claim 20, further comprising:
(b) pre-drilling the corresponding hole in the object to widen the hole for receiving the hollow and elongated bit, wherein step (b) is performed prior to step (a).

22. The method of claim 16, further comprising:
(c) cutting off a head portion of the fastener at or near the surface of the object to provide access to the elongated portion of the fastener by the hollow and elongated bit, wherein step (c) is performed prior to step (a).

23. The method of claim 16, further comprising:
(d) inserting a threaded insert into the hole drilled out to remove the fastener during step (a), wherein step (d) is performed after step (a).
